(19) United States
(12) Patent Application Publication
(10) Pub. No.: US 2008/0281489 A1
(43) Pub. Date: Nov. 13, 2008

(54) Method for Controlling the Orientation of the Rear Wheels of a Vehicle

(75) Inventor: Yves Le Vourch, Le Chesnay (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT S.A.S., BOULOGNE-BILLANCOURT (FR)

(21) Appl. No.: 11/814,250

(22) PCT Filed: Jan. 17, 2006
(86) PCT No.: PCT/FR2006/050018

§ 371 Date: Feb. 13, 2008

(30) Foreign Application Priority Data
Jan. 18, 2005 (FR) 0500503

(51) Int. Cl. B62D 6/00

(52) U.S. Cl. 701/41

(57) ABSTRACT

A method for controlling orientation of rear wheels of a vehicle, by a computerized control system, including a module for calculation of a deflection angle for the rear wheels as a function of a deflection angle of the front wheels. In the method, when the front wheels are oriented for a period of time such that the vehicle follows a curved trajectory with an inner side and an outer side, the rear deflection angle, as determined by the calculation module, is corrected and limited to a maximum value calculated instantaneously such that a rear corner then follows a trajectory remaining within the curved trajectory previously followed by a front corner and, furthermore, at a tangent to the same.

The subject of the invention is a method for controlling the orientation of the rear wheels of a vehicle having two sets of orientable wheels, these being at least one steered front wheel and at least one rear wheel that can also be steered, respectively, so as to reduce the turning circle of the vehicle.

In general, a land vehicle, particularly a motor car, comprises a body bearing a cabin and resting on the ground, usually via four wheels, these being two steered front wheels controlled by the driver and two rear wheels which usually are directed along the longitudinal axis of the vehicle. In some cases, however, particularly on all-terrain vehicles, it is advantageous also to be able to orientate the rear wheels of the vehicle.

This orientation of the rear wheels is determined as a function of the steering angle of the front wheels as controlled by the driver, taking into account the speed of the vehicle. This is because, at a relatively low speed, for example in a garage or a parking lot or on uneven ground, it is advantageous to reduce the turning circle by turning the rear wheels in the opposite direction to the steering angle of the front wheels which, at low speed, may be a large angle. By contrast, at higher speed, the steering angle of the front wheels is quite small and it is preferable to keep the rear wheels aligned with the vehicle for running practically in a straight line or even for achieving an “oversteer” effect by turning the rear wheels in the same direction as the front wheels.

The possibility of orientating the rear wheels therefore affords certain advantages. However, turning the rear wheels in the opposite direction to the front wheels carries the risk of causing the rear part of the vehicle to step out beyond the path followed by the front part. A situation such as this could prove dangerous when the driver is avoiding an obstacle because he cannot be sure that the rear part of the vehicle will avoid the obstacle in the same way as the front part, and it may be difficult to predict the path of the rear part, especially when the rear overhang is relatively long.

Likewise, when the vehicle is leaving a parking space with a relatively large amount of steering lock, turning the rear wheels in the opposite direction makes it easier to pull clear by reducing the turning circle but may, on the other hand, cause the rear overhang to strike an obstacle positioned alongside this parking space, for example a signpost.

It is an object of the invention to overcome such disadvantages without excessively complicating the computerized system used to control the orientation of the rear wheels.

The invention is therefore concerned, in general, with a method for controlling the orientation of the rear wheels of a vehicle having at least one steered front wheel and at least one orientable rear wheel the orientation of which is controlled by a computerized control system comprising a module for calculating a steering angle for the rear wheels as a function of the steering angle of the front wheels controlled by the driver, the vehicle having a substantially rectangular shape with two front corners and two rear corners overhanging in front of the front wheels and behind the rear wheels, respectively.

According to the invention, when the front wheels have been orientated by the driver in such a way that, for a period of time, the vehicle is following a curved path with an inside and an outside, the steering angle of the rear wheels determined by the calculation module is corrected and limited to a maximum value calculated at each instant so that the outside corner of the rear overhang, during the same period of time, follows a path that remains inside the path followed earlier by the outside corner of the front overhang and is at most tangential thereto.

In a particularly advantageous manner, while the vehicle is moving along its path, the computerized control system measures, at each instant, a collection of parameters representative of the displacement, including at least the current longitudinal speed of the vehicle, with a positive sign forwards, and the angles of orientation of the front and rear wheels with a positive sign in the clockwise direction and stores in memory, for a series of basic positions separated from one another along the path by the same elementary displacement, the mean values of said parameters calculated, over the elementary displacement, between each basic position and the previous basic position. Thus, during the elementary displacement following a basic position, the control system can, at each instant, calculate a corrected rear steering angle such that the resulting path for the rear corner, taking the length of the vehicle and the mean values of the parameters stored in memory into consideration, remains inside the path followed earlier by the front corner lagging behind the latter by a distance corresponding to the length of the vehicle.

To do this, as the front corner enters a basic position, the control system defines an orthonormal frame of reference for the vehicle having, as its origin, the center of gravity of this vehicle and having, for its abscissa axis, the longitudinal axis of the vehicle and, on the basis of the mean values of the representative parameters stored in memory in respect of said basic position, formulates the equation, in said frame of reference, of an imaginary path equivalent to the path followed earlier by the front corner over a length behind that corresponds to the length of the vehicle and, by taking it that, during the next elementary displacement, the front corner follows a forward continuation of said imaginary path and that the front steering angle is maintained, determines the predicted path of the rear corner resulting from said front angle and corrects the rear angle so that this predicted path of the rear corner remains inside and is at most tangential to the equivalent earlier path of the front corner, lagging behind the latter by a distance corresponding to the length of the vehicle.

In a preferred embodiment, the length of an elementary displacement between two basic positions is determined in such a way that, in the path of the front corner, the length of the vehicle represents an integer number of elementary displacements, and the equation of the path equivalent to the path of the front corner is formulated from the mean values of the parameters stored in memory for the same number of earlier basic positions, working back to a much earlier position lagging behind the basic position by a distance substantially equal to the length of the vehicle.

In a particularly advantageous manner, the equation for the equivalent earlier path of the front corner is formulated, for each basic position, as a function of the mean values of the lateral speed and of the yaw rate of the front corner, said mean values being calculated from the mean longitudinal speed and the mean front steering angles and rear steering angles stored in memory for the relevant basic position.

Likewise, the predicted path of the rear corner during the elementary displacement following a basic position is determined from the mean values, calculated in this way, of the lateral speed and of the yaw rate of the front corner during the previous elementary displacement.

As a preference, in the elementary displacement following a basic position, the control system likens the portion of path followed by the front corner to a continuation of the equivalent earlier path and at each instant determines the ordinate value of the rear corner in the frame of reference of the vehicle corresponding to the relevant basic position so as to calculate a rear steering angle such that said instantaneous ordinate value of the rear corner does not exceed the ordinate value of the point with the same abscissa value on the equivalent path in said frame of reference of the relevant basic position.

According to another particularly advantageous feature, the earlier path equivalent to the path followed by the front corner is an arc of a circle and, over the elementary displacement following a basic position of the front corner the control system likens the path portion followed, at each instant, by the earlier position of the front corner lagging behind its instantaneous position by the length of the vehicle, to the corresponding portion of the chord of said arc of a circle passing through the front corner and its earlier position in order, at each instant, to predict the future displacement of said earlier position and correct the rear steering angle accordingly so that the path followed by the rear corner remains separated from and is at most tangential to said chord.

According to another preferred feature, the control system formulates, for each basic position, the equation of the equivalent earlier path in the frame of reference corresponding to this basic position and keeps the same frame of reference and the same equivalent path to correct the rear steering angle in the next elementary displacement, said frame of reference and said equation of the equivalent path being readjusted in the next basic position as a function of the mean values of the parameters stored in memory in this position in order, during the next displacement, to calculate the correction for the rear angle in the new frame of reference and from the corrected equivalent-path equation.

Other advantageous features of the invention relating, in particular, to the equations used and the way in which the correction is calculated, will become more apparent in the following description of one particular embodiment, which is given by way of nonlimiting example with reference to the attached drawings.

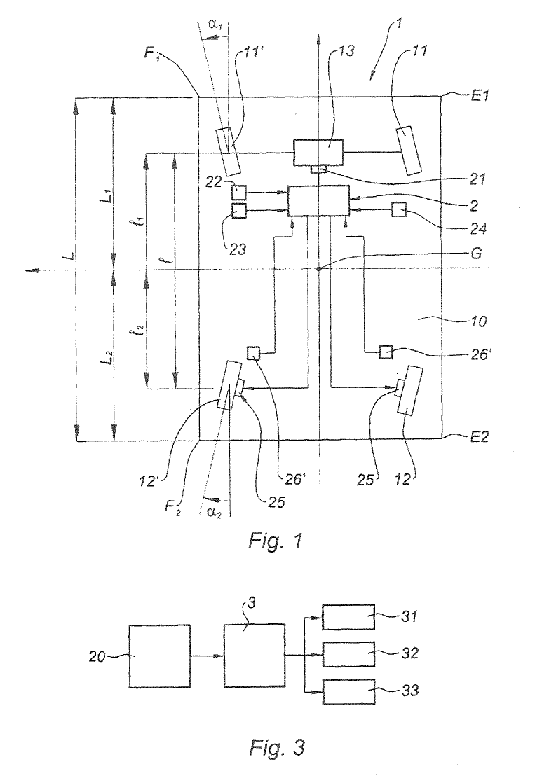

FIG. 1 is a diagram of a vehicle with four-wheel steering.

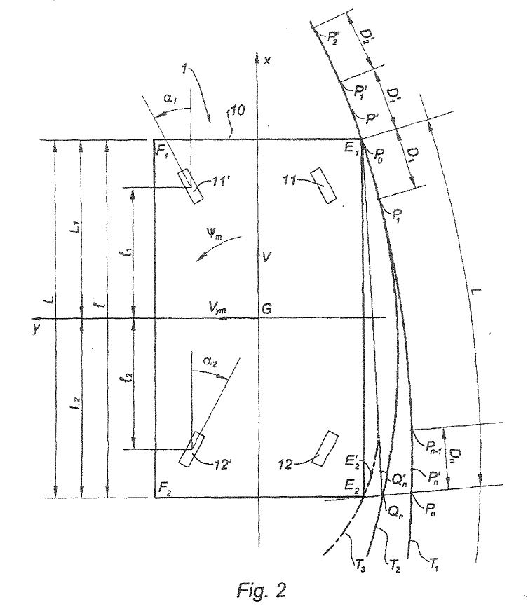

FIG. 2 is a diagram illustrating the behavior of the vehicle when cornering.

FIG. 3 is a diagram of the computerized control system.

FIG. 1 schematically depicts a vehicle 1 having a substantially rectangular body 10 borne by four orientable wheels, namely two steered front wheels 11, 11 and two rear wheels 12, 12′ which are connected to the chassis of the body 10 by a suspension mechanism, not depicted.

The front wheels 11, 11′ are orientated by means, for example, of a steering rack 13, as a function of commands received, mechanically or electrically, from a steering wheel (not depicted) operated by the driver.

The orientation of the rear wheels 12, 12′ is controlled as a function of the steering angle α₁ of the front wheels, by a computerized control system comprising a control unit 2 which receives information corresponding to a collection of parameters representative of the displacement of the vehicle and supplied by various sensors, namely a sensor 21 that senses the degree of steering lock applied to the front wheels 11, 11′, a sensor 22 that senses the rotational speed of the front wheels in order to determine the longitudinal speed V of the vehicle, a sensor 23 that senses the yaw rate ψ, that is to say the rate at which the vehicle rotates about a vertical axis passing through a point G considered to be its center of gravity, and a sensor 24 that senses the lateral acceleration at the center of gravity.

The orientation of the rear wheels 12, 12′ is controlled by actuators 25 under the control of the control system 2 which comprises a means for calculating a steering angle α₂ for the rear wheels as a function of the information received and, in particular, of the steering angle α₁ of the front wheels, so as to reduce the turning circle as far as possible.

The rear steering angle α₂ is measured by sensors 26.

The various position and speed sensors may be of optical or magnetic type, for example Hall-effect sensors.

The control unit 2 may be produced in the form of a microprocessor equipped with random access memory, read only memory, a central processing unit and input/output interfaces so that it can receive information from the various sensors and send instructions to the actuators 25.

Advantageously, the longitudinal speed V of the vehicle can be obtained by calculating the mean of the speed of the front wheels or of the rear wheels, which speed can be measured by the sensors of an ABS system.

In general, the vehicle body usually has a roughly rectangular shape with two front corners E₁, F₁ and two rear corners E₂, F₂ which are positioned at distances L₁ in front of and L₂ to the rear of the center of gravity G, respectively, while the front and rear wheels are positioned inboard with respect to the body 10, at distances l₁ and l₂ respectively from the center of gravity, which distances are, of course, shorter than L₁ and L₂ respectively. There is therefore a front overhang L₁−l₁ and a rear overhang L₂−l₂, which overhangs may differ in magnitude according to the type of vehicle.

In general, the driver orientates his front wheels in such a way that the front corner E₁ of the vehicle, positioned on the outside of the curve, avoids the obstacles, either during normal driving or when entering or leaving a parking space.

In vehicles that have just two orientable front wheels and two rear wheels directed along the longitudinal axis, the path of the outside rear corner E₂ always remains inside the path of the front corner E₁. By contrast, if the rear wheels are orientated in the opposite direction to the front wheels in order to reduce the turning circle, the path of the rear corner E₂ may intersect with that of the front corner E₁ and the rear part of the vehicle therefore runs the risk of striking obstacles that the driver had avoided with the front end.

According to the invention, the control system 2 is designed in such a way as to solve such a problem using simple means.

FIG. 2 schematically depicts, by way of example, a vehicle 1 turning to the left with a positive angle α₁ of orientation at the front wheels 11, 11′ and the right front corner E₁ of which is describing a path T₁.

As mentioned above, the control system 2 at each instant measures a collection of parameters supplied by the various sensors and including, at least, the current longitudinal speed V with its sign, and the angles of orientation of the front and rear wheels, α₁ and α₂ respectively.

Furthermore, the control system calculates the means of the instantaneous values thus measured over a series of successive elementary displacements of length D in the path T1 and stores these mean values in memory for a series of basic positions each one corresponding to the end of an elementary displacement. As a preference, this elementary displacement D is chosen such that the distance L, equal to the length of the vehicle, corresponds to an integer number n of elementary displacements.

In the path T₁, P₀ denotes a basic position occupied by the front corner E₁ at the end of an elementary displacement D₁ and Pₙ denotes the lagging position occupied earlier and lagging behind the point P₀ by a distance L equal to the length of the body 10 of the vehicle.

Thus, before reaching a basic position P₀ in the path T₁, the front corner E₁ of the vehicle first of all, over a distance corresponding to the length of the vehicle, passing through a succession of basic positions Pₙ/Pₙ₋₁, . . . , P₂, P₁, P₀ which are separated from one another by an elementary distance D and, for each of these positions, the control system will have stored the mean values of the parameters calculated during the previous elementary displacement.

The calculation means allow fairly short elementary displacements, for example measuring from 30 to 50 centimeters, to be performed, so that the number n of elementary displacements corresponding to the length L of the vehicle is of the order of 15 to 20, which is a value consistent with the capabilities of computerized calculation.

In the case depicted in FIG. 2, the outside front corner E₁ is therefore, at the instant in question, in a basic position P₀ and the system has, in memory, the mean values of the parameters calculated during the previous elementary displacements D₁, D₂, . . . , Dₙ.

In order to perform the calculations, the control system advantageously uses a two-wheel model of known type.

In each basic position P₀, the mean values of the front angle, of the rear angle and of the longitudinal speed, denoted α₁ₘ, α₂ₘ and Vₘ respectively, can be used to reconstruct, in the frame of reference of the vehicle defined by the axes Gx Gy, a mean lateral speed V_{ym} and a mean yaw rate ψₘ which are given by the equations:

V_{ym}=Vₘ*(l₂α₁ₘ+l₁α₂ₘ)/(l₁+l₂) (1)

ψₘ=Vₘ*((α₁ₘ−α₂ₘ)(l₁+l₂) (2)

From these equations it is possible to define a mean path T₂ consisting of a mathematical line passing as closely as possible through the various positions Pₙ, Pₙ₋₁, . . . , P₁, P₀ occupied by the front corner E₁ as it moves along the path T1, along the length L of the vehicle, and the two-wheel model for which makes it possible to formulate the equation in the Gx, Gy frame of reference.

This mathematical line T₂ can be considered to be a mean path equivalent to the path T₁ actually followed by the front corner E₁ as far as the basic position P₀.

From this equation formulated by the two-wheel model, the control system determines the ordinate value, on the equivalent line T₂, of the lagging position Qₙ which, on this equivalent path, is behind the basic position P₀ by a distance L equal to the length of the vehicle and therefore corresponding to the earlier position Pₙ of the front corner lying n elementary displacements earlier than the basic position P₀.

In practice, the ordinate value thus calculated can be written:

Y_{Q}=Vₘ/ψₘ−[(L₁+V_{ym}/ψₘ)²+(Vₘ/ψₘ)²−(L₂+V_{ym}/ψₘ)²]^{1/2} (3)

in which:
Vₘ is the mean longitudinal speed over the displacement D
ψₘ is the mean yaw rate
L₁ is the abscissa value for the front corner E1 in the Gx,Gy frame of reference
V_{ym} is the mean lateral speed of the front corner
L₂ is the abscissa value of the rear corner.

By keeping the Gx, Gy frame of reference of the vehicle corresponding to the basic position P₀, the two-wheel model makes it possible to determine the equation for the future path T₃, in this frame of reference, of the rear corner E₂ during the next elementary displacement D′₁ of the front corner E₁. To do that, it is taken that the mean values of the parameters stored in memory at P₀ are kept as, therefore, are the mean longitudinal speed Vₘ and the mean yaw rate ψₘ indicated above.

To each instantaneous position P′ of the front corner there corresponds, in the path T₁, an earlier position P′ₙ, lagging behind this instantaneous position P′ by the length of the vehicle.

By approximation, the path followed, over the displacement Dn, by the lagging earlier position P′ₙ is likened to the chord P₀Qₙ of the equivalent path T2.

Furthermore, because it is taken that the mean front angle α₁ₘ, the longitudinal speed Vₘ, the lateral speed V_{ym} and the yaw rate ψₘ are kept for the displacement D′₁, it may be taken that the rear corner E₂ follows an approximate path which, in the Gx, Gy frame of reference, is a portion of an arc of a circle T₃.

Using these approximations, the control system can thus calculate, at each instant, a correction α′₂ to be applied to the rear steering angle α₂ so that, in the Gx, Gy frame of reference, the ordinate value for the rear corner E′₂ at this instant does not exceed the ordinate value for the corresponding point Q′ₙ on the chord P₀ Qₙ of the equivalent path T₂, the arc of a circle T₃ thus being at most tangential to the chord P₀ Qₙ.

Given that the chord P₀ Qₙ is always positioned on the inside of the arc of a circle T₂ equivalent to the actual path T₁ followed by the front corner E₁, the rear corner E₂ will always remain inside this path T₁ and will thus avoid the obstacles that the driver had already avoided by turning the front wheels 11, 11′.

In practice, the correction α′₂ to be made, at each instant, to the rear angle α₂ can be obtained by sequentially calculating the following parameters:

a₁=−1/α₁; b₁=l₁/α₁

a₂=Y_{P′n}/(L₂−L₁); b₂=−L₁/(L₂−L₁)

a₄=(1+a₁a₂)/(1+a₂²); b₄=(b₁−b₂)a₂/(1+a₂²)

a₅=a₂a₄; b₅=b₄a₂+b₂

a₆=(a₄−1)²+(a₁−a₅)²−1−a₁²

b₆=L₂+(a₄−1)b₄+(a₁−a₅)(b₁−b₅)−a₁b₁

c₆=b₄²+(b₁−b₅)²−L₂²−b₁²

A=[−b₆−2[b₆²−a₆c₆]^{1/2}]/2a₆

the correction to be made to the rear angle α₂ being:

a′₂=−a₁(L₂+A)/(L₁−A). (4)

In order to implement the method according to the invention, the control system 2, which may be of a conventional type, is modified in the way schematically depicted in FIG. 3 and in general comprises a module 20 for calculating the rear angle α₂ as a function of the front angle α₁ and a supervisory unit 3 which controls activation or deactivation of the three units that calculate the correction α′₂ to be made to the rear angle α₂ determined by the module 20 and each corresponding to a strategy, these being the module 31 for a straight-line strategy, the module 32 for a cornering strategy and the module 33 for a strategy of not limiting the rear angle.

The supervisory module 3 comprises inputs receiving signals emitted by the various sensors 22, 23, 24, 26 and corresponding to the parameters representative of the displacement of the vehicle, namely:
the current longitudinal speed V of the vehicle
the current steering angles α₁ of the front wheels and α₂ of the rear wheels
the sign of the longitudinal speed V which is positive when traveling in a forwards gear and negative in reverse gear.

By using a two-wheel model in the way indicated above, the supervisory module 3 calculates, for each elementary displacement D between two successive basic positions, the mean values of the longitudinal speed Vₘ, of the lateral speed V_{ym} and of the yaw rate ψₘ of the outside front corner E₁ in its path T₁.

The mean values thus calculated are compared with limit values recorded in advance, these being respectively:
a minimum longitudinal speed Vₘᵢₙ below which the vehicle is considered to be stationary,
a maximum speed Vₘₐₓ at which the strategy can be activated,
a minimum yaw rate α₀ below which the reconstructed path is considered to be a straight line,
a maximum front angle α₀ below which no limitation is to be applied to the rear steering angle.

At the end of each elementary displacement, the mean values of the parameters stored in memory in the basic position reached at that moment are therefore compared against the recorded limit values.

If the mean longitudinal speed Vₘ is above the limit Vₘₐₓ, the speed is too high for it to be possible to act upon the rear wheels and the supervisory module 3 runs the non-limitation module 33. In the conventional way, the rear wheels in this case remain aligned with the vehicle or rather alternatively orientated slightly in the same direction as the front wheels, in order to improve roadholding.

Furthermore, if the absolute value of the current front angle is below the limit α₀, it is taken that the path is a straight line and once again it is the non-limitation module 33 which is run.

If, in a basic position, the sign of the mean longitudinal speed is negative, that means that some of the preceding elementary displacement was performed in reverse gear, so the non-limitation module 33 is run.

As long as the longitudinal speed V does not exceed the limit Vₘᵢₙ, the vehicle is considered to be stationary. The speeds and the angles in the basic position at this instant are therefore initialized in order to provide the conditions for exiting the parking space.

Thus:

Vₘ=Vₘᵢₙ; α₁ₘ=0; α₂ₘ=0.

In movement, the mean values α₁ₘ, α₂ₘ, Vₘ make it possible, as has already been seen, to reconstruct the mean lateral speed and the mean yaw rate which define the mean path T₂ equivalent to the path T₁ of the front corner E₁.

If the absolute value of the yaw rate ψₘ is above the limit ψ₀, the equivalent path T₂ is considered to be a circular path. The supervisory module 3 does, however, give consideration to the sign of ψₘ resulting from equation (2). If the mean yaw rate ψₘ and the mean steering angle α₁ₘ during the displacement D₁ preceding the relevant basic position P₀ are of the same sign, then the supervisory module 3 runs the “cornering strategy” module 31 which calculates the correction α′₂ to be made to the rear angle α₂ in the way indicated above.

By contrast, if ψₘ and α₁ₘ are of opposite signs, that means that, during the previous displacement D₁, the driver changed the direction in which he was steering and, in this case, the supervisory module 3 runs the “no limitation” module 33 which keeps the rear steering angle α₂ as calculated by the calculation module 21 without applying any correction to it.

The same is true if the lateral speed V_{ym} resulting from equation (1) is of the opposite sign to the front steering angle α₁. In this case, too, the driver has changed the direction of steering and the “no limitation” module 33 is run.

However, if the absolute value of the mean yaw rate ψₘ is below the limit ψ₀, the path is considered to be a straight line. In this case, if the lateral speed V_{ym} is of the same sign as the front steering angle α₁, the supervisory module 3 runs the “straight line strategy” module 31 which calculates the restriction on angle α′₂ in the way indicated above for the “cornering strategy” by applying the same sequential calculation (4) from the current angle α₁ measured at each instant and the mean values of the longitudinal speed Vₘ and the lateral speed V_{ym} in the previous displacement D₁, the correction α′₂ to be applied to the rear angle α₂ calculated by the calculation module 20 being given by the equation:

α′₂=−α₁(L₂+A)/(L₁−A) (4)

When the front angle α₁ is positive, if it turns out that the calculated correction α′₂ is also positive, the wheels are brought back into line with the axis of the vehicle, the corrected rear angle α₂₀ being zero. By contrast, if the correction α′₂ is negative, the corrected rear angle α₂₀ is equal to the maximum value of the angle α₂ initially calculated and of the correction α′₂.

Conversely, if the front steering angle α₁ is negative and if the calculated correction α′₂ is also negative, the corrected rear angle α₂₀ is zero, the wheels being brought into line with the axis of the vehicle.

If the correction α′₂ is negative, the corrected rear angle α₂₀ is equal to the minimum value of the initial angle α₂ and of the correction α′₂.

In all the cases indicated above in which the supervisory module 3 has to run the “no limitation” module 33, the calculated rear angle α₂ is kept unchanged.

The invention therefore makes it possible, without excessively complicating the control system, to correct the rear steering angle instantaneously in order to prevent the rear overhang from stepping outside the path chosen by the driver.

Of course, the invention is not restricted to the preferred embodiment described but on the contrary covers all variants thereof which fall within the claimed scope of protection and employ equivalent means.

For example, the equations for the paths T₂ and T₃ were formulated using a two-wheel model of known type, but other models and other equations could be used.

Likewise, the mathematical line equivalent to the actual path is not necessarily an arc of a circle and, although it is particularly advantageous to use the chord of this arc as an approximation, other calculation means might be possible.

Furthermore, other representative parameters could be used in order to put the displacement of the vehicle into equation form.

1-12. (canceled)

13. A method for controlling orientation of rear wheels of a vehicle having a body of longitudinal axis and borne by orientable wheels on each side of the axis, the orientable wheels being at least one steered front wheel and at least one rear wheel, respectively, orientation of the front wheels being controlled by a driver so as to follow a path and the orientation of the rear wheels being under control of a computerized control system including a module for calculating a steering angle of the rear wheels as a function of the steering angle of the front wheels, the body of the vehicle having a substantially rectangular shape with two front corners and two rear corners overhanging in front of the front wheels and behind the rear wheels, respectively, in which method:
when the front wheels have been orientated, for a period of time, such that the vehicle follows a path that has an inside and an outside, the computerized control system determines, at successive intervals of time each corresponding to a basic position, an imaginary path equivalent to the path followed earlier by the front corner over a length corresponding to the length of the vehicle, behind a relevant basic position of the front corner and calculates, at each instant, a corrected rear steering angle such that the resulting path for the rear corner, taking into consideration the length of the vehicle, remains inside the imaginary path,
wherein, to determine the imaginary path behind a basic position, the computerized control system measures, at each instant, a collection of parameters representative of displacement, including at least the current longitudinal speed of the vehicle, with a positive sign forwards, and the angles of orientation of the front wheels and of the rear wheels, with respect to the longitudinal axis of the vehicle, with a positive sign in the clockwise direction and, as the vehicle moves, divides the path followed by the front corner into a series of elementary displacements between a series of basic positions and, as the front corner enters a basic position, defines an orthonormal frame of reference for the vehicle having, as its origin, the center of gravity and two perpendicular axes, the axes being an abscissa axis corresponding to the longitudinal axis of the vehicle and an ordinates axis, and
wherein, based on mean values of representative parameters stored in a memory in respect of the basic position, the control system formulates an equation, in the frame of reference of the vehicle, of an equivalent path of the front corner and, by taking it that, during a next elementary displacement, the front corner follows a forward continuation of the imaginary path and that the front steering angle is maintained, determines the predicted path of the rear corner and corrects the rear steering angle so that this predicted path of the rear corner remains inside and is at most tangential to the equivalent path of the front corner lagging behind the latter by a distance corresponding to the length of the vehicle.

14. The method as claimed in claim 13, wherein the length of an elementary displacement is determined such that, in the path of the front corner, the length of the vehicle represents an integer number of elementary displacements.

15. The method as claimed in claim 14, wherein the equation of the path equivalent to the path of the front corner is formulated from the mean values of the parameters stored in the memory for earlier basic positions, working back to an earlier position lagging behind the basic position by a distance substantially equal to the length of the vehicle.

16. The method as claimed in claim 15, wherein the equation for the equivalent path of the front corner is formulated, for each basic position, as a function of mean values of lateral speed and of yaw rate of the front corner, the mean values being calculated from mean longitudinal speed and mean front steering angles and rear steering angles stored in the memory for the relevant basic position.

17. The method as claimed in claim 16, wherein the predicted path of the rear corner during the elementary displacement following a basic position is determined from the mean values of the lateral speed and of the yaw rate of the front corner during a previous elementary displacement.

18. The method as claimed in claim 17, wherein, in the elementary displacement following a basic position, the control system likens a portion of path followed by the front corner to a continuation of the equivalent earlier path and at each instant determines an ordinate value of the rear corner in the frame of reference of the vehicle corresponding to the basic position so as to calculate a rear steering angle such that an instantaneous ordinate value of the rear corner does not exceed an ordinate value of the point with the same abscissa value on the equivalent path in the frame of reference of the basic position.

19. The method as claimed in claim 14, wherein the earlier path equivalent to the path followed by the front corner is an arc of a circle, and wherein, in the elementary displacement following a basic position of the front corner, the control system likens the portion of path followed, at each instant, by the earlier position, which lags behind an instantaneous position by the length of the vehicle, to the corresponding portion of the chord of the arc of a circle in order, at each instant, to predict future displacement of the earlier position and correct the rear steering angle accordingly so that the path followed by the rear corner remains separated from and at most tangential to the chord.

20. The method as claimed in claim 14, wherein, for each basic position, the control system formulates the equation for the equivalent earlier path in the frame of reference corresponding to the position and keeps the same frame of reference and the same equivalent path to correct the rear steering angle during the next elementary displacement, and wherein, in the next basic position, the control system readjusts the frame of reference of the vehicle and corrects the equation for the equivalent path as a function of mean values of the parameters stored in the memory in a next position, in order, in a next displacement, to calculate the correction for the rear angle in a new frame of reference for the position and from the corrected equivalent-path equation.

21. The method as claimed in claim 16, wherein the mean values of the lateral speed and of the yaw rate of the outside front corner in an elementary displacement between a basic position and the previous basic position are given by the equations:
V_{ym}=Vₘ*(l₂a₁ₘ+l₁a₂ₘ)/l
ψₘ=Vₘ*(a₁ₘ−a₂ₘ)/l
in which:
Vₘ is the mean longitudinal speed,
α₁ₘ is the mean angle of orientation of the front wheels,
α₂ₘ is the mean angle of orientation of the rear wheels,
l₁ is the distance between the front wheels and the center of gravity,
l₂ is the distance between the rear wheels and the center of gravity,
l=l₁+l₂ is the wheelbase of the vehicle.

22. The method as claimed in claim 21, wherein, from the mean values of the lateral speed of the front corner and of the yaw rate, the control system determines the ordinate value, in the frame of reference of the vehicle, of a position lagging behind the basic position of the front corner, using the formula:
Y_{Q}=Vₘ/ψₘ−[(L₁+V_{ym}/ψₘ)²+(Vₘ/ψₘ)²−(L₂+V_{ym}/ψₘ)²]^{1/2}
in which:
Vₘ is the mean longitudinal speed during the displacement D,
ψₘ is the mean yaw rate,
L₁ is the abscissa value for the front corner,
V_{ym} is the mean lateral speed of the front corner,
L₂ is the abscissa value for the rear corner,
and the method corrects the rear steering angle to take account of future paths of the front corner and of the rear corner, and of a future path of instantaneous lagging earlier position, this future path being likened to the chord of the equivalent path so that, during the next elementary displacement of the front corner, the ordinate value of the rear corner remains lower than and at most equal to the ordinate value, calculated in this way, of a point of the chord corresponding to the earlier position.

23. The method as claimed in claim 22, wherein the control system determines the correction to be made to the rear steering angle as a function of the front steering angle and rear steering angle, abscissa values for the front corner and for the rear corner, a distance from the front wheels to the center of gravity, and a distance from the rear wheels to the center of gravity and an ordinate value of the lagging position, by sequentially calculating the following parameters:
a₁=−1/α₁; b₁=l₁/α₁,
a₂=Y_{Q}/(L₂−L₁); b₂=−L₁/(L₂−L₁),
a₄=(1+a₁a₂)/(1+a₂²); b₄=(b₁−b₂)d₂/(1+a₂²),
a₅=a₂a₄; b₅=b₄a₂+b₂,
a₆=(a₄−1)²+(a₁−a₅)²−1−a₁²,
b₆=L₂+(a₄−1)b₄+(a₁−a₅)(b₁−b₅)−a₁b₁,
c₆=b₄²+(b₁−b₅)²−L₂²−b₁²,
A=[−b₅−2[b₆²−a₆c₆]^{1/2}]/2a₆,
the correction to be made to the rear angle α₂ being:
α₂′=−α₁(L₂+A)/(L₁−A).

24. The method as claimed in claim 13, wherein the control system chooses, as a function of values measured at each instant for the longitudinal speed and the front and rear steering angles, and mean values of lateral speed and yaw rate, any one of at least three rear steering angle corrections strategies, these being:
a non-correction strategy in any one of the following instances:
if the mean longitudinal speed is negative;
if the mean longitudinal speed is greater than a given limit Vmax;
if the absolute value of the front steering angle is below a given limit;
if the mean yaw rate and/or the mean lateral speed is of opposite sign to the front steering angle
a straight-line strategy is an absolute value of the mean yaw rate is below a given limit;
a cornering strategy if the absolute value of the mean yaw rate is above a limit.
